(19) United States
(12) Patent Application Publication
(10) Pub. No.: US 2008/0131627 A1
(43) Pub. Date: Jun. 5, 2008

(54) Board with crosswise center medium

(76) Inventors: Nadine Cino, New York, NY (US); Martin Spindel, New York, NY (US)

Correspondence Address: PRYOR CASHMAN, LLP, 410 PARK AVENUE, NEW YORK, NY, 10022, US

(21) Appl. No.: 11/633,394

(22) Filed: Dec. 4, 2006

(51) Int. Cl. F16B 5/07

(52) U.S. Cl. 428/33

(57) ABSTRACT

A set of two compatible half-boards that can be pressed together to form a whole board. Each half-board comprises elements of a center medium that inter-fit with the other half-board to form a pattern of shapes. After two half-boards have been inter-fitted, the fully formed board comprises a crosswise center medium sandwiched between a pair of opposed outer sheets. The center medium runs crosswise to the outer sheets. In the preferred embodiment, the crosswise center medium forms a repeating pattern of closed, hollow honeycomb (hexagonal) shapes. In alternative embodiments, the crosswise center medium comprises other shapes.

### BACKGROUND

The present invention comprises a set of two compatible and complementary half-boards that can be pressed together to form an integrated whole board. Each half-board consists of an outer sheet and a set of “elements” that project from one side of the sheet and are attached crosswise to it. The elements are wall-like structures that, in most cases, project outwardly between 1/16″ and 1″ from the sheet—although projections beyond those parameters are possible. After two half-boards have been pressed together—the elements inter-fit with each other to form a center medium that runs crosswise between the outer sheets. In the preferred embodiment, the crosswise center medium forms a repeating pattern of closed, hollow honeycomb (curved-wall hexagonal) shapes and the board is flat and made from plastic.

Items that can be made from these finished boards with crosswise center mediums include containers and dunnage. In many applications, boards with crosswise center mediums provide superior strength, as compared to boards with mediums that run along or parallel to their outer sheets (commonly seen in corrugated boxes), or as compared to boards without center mediums (even allowing for boards of equal weight, length, width and material).

Heretofore, boards with crosswise center mediums have been manufactured as flat rectangular pieces, and secondarily die cut into the desired shape. An important advantage of the present invention is that a board (with a crosswise center medium) can be molded in its final shape in a single manufacturing operation, thereby, eliminating the need for a secondary die cutting operation. Furthermore, the molded shape can contain design elements that would be more difficult and expensive to create under the die cutting method. Finally, the molding process employed with the present invention typically allows parts to be produced with a smoother and more finished looking edge than can be achieved with die cutting.

In certain applications the finished board of the present invention may reduce the number of walls, or plies of material, that would otherwise be required. Finally, a single board of the present invention can be easily manufactured with varying thicknesses. Such variation would be difficult to achieve under the production methods available heretofore.

### SUMMARY

A fully formed board of the present invention comprises a crosswise center medium sandwiched between a pair of opposed outer sheets. The crosswise center medium is formed by inter-fitting sets of wall-like elements that project outwardly from each outer sheet. Each combination of an outer sheet and an attached set of elements is referred to herein as a “half-board.”

In the preferred embodiment, the crosswise center medium forms a repeating pattern of closed, hollow honeycomb (curved-wall but basic hexagonal) shapes and the half-boards are flat and made from plastic. The repeating pattern of shapes covers, essentially, the entire area of the board that lies between the pair of opposed outer sheets. The elements of each of the pair of opposed outer sheets are identical in shape, but offset with respect to each other along both the horizontal and vertical axes. In certain alternative embodiments, the wall elements are not identical in shape, and are positioned along the horizontal and vertical axes so as to inter-fit with each other.

In alternative embodiments, the aforementioned crosswise center medium may comprise a large variety of shapes (other than honeycomb); a single board may comprise uneven or varied thicknesses (the board would not be flat); the overall shape of the board may be curved or otherwise non-linear; and the board may be made from a variety of materials other than plastic including, without limitation, paper. Also, in alternative embodiments, the crosswise center medium could cover significantly less than the entire area of the board that lies between the pair of opposed outer sheets.

### BRIEF DESCRIPTION OF THE DRAWINGS

Each of FIGS. 1A and 1B is a top perspective view of a half-board, showing one projecting wall element from which one row of a crosswise center medium is formed. The element of one half-board can be combined with the element of the opposed mirror-like and other half-board to form the basic honeycomb shape of the preferred embodiment of a whole board.

FIGS. 1C and 1D are side perspective views of the half-boards of FIGS. 1A and 1B, respectively.

FIG. 1E is a top perspective view of the half-board of FIG. 1A after it has been inverted or flipped, and then positioned above the half-board of FIG. 1B, just before the two half-boards are pressed together.

FIG. 1F is a top perspective view of the half-boards of FIGS. 1A and 1B after they have been pressed together, thereby, forming a full board of the preferred embodiment.

FIGS. 2A and 2B are top views of two half-boards with projecting wall elements, molded in the shape of a keyhole, i.e., a circle atop a trapezoidal-shaped base.

FIG. 2C is a top view, showing the half-board of FIG. 2A flipped over and positioned above the half-board of FIG. 2B, just before the two half-boards are pressed together.

FIG. 2D is a top view, showing the half-boards of FIGS. 2A and 2B after they have been pressed together, thereby, forming a full board of the preferred embodiment.

FIG. 2E is a front perspective view of FIG. 2D in which the circular portion of the half-board shown in FIG. 2A has been separated from its half-board counterpart, and turned downward.

FIG. 2F illustrates a cut line, that serves as a “living-hinge,” made in FIG. 2E. FIG. 2F is illustrated with the circular portion of the half-board shown turned upward.

FIGS. 3A and 3B are top perspective views, showing the half-boards of an alternative embodiment in which elements of the crosswise center medium on each half-board comprise a continuous gradient of thicknesses or projections from the flat surfaces of the outer sheets.

FIGS. 3C and 3D are top perspective views of FIGS. 3A and 3B, turned 90 degrees clockwise.

FIG. 3E is a side view of the half-board of FIG. 3C flipped over and positioned above the half-board of FIG. 3D, just before the two half-boards are pressed together.

FIG. 3F is a side view of the half-boards of FIGS. 3C and 3D after they have been pressed together, thereby, forming a full board of an alternative embodiment.

FIGS. 4A thru 4C are side views, showing an alternative embodiment in which the half-boards (of FIGS. 4A and 4B) combine (in FIG. 4C) to comprise discrete steps of different thicknesses across the length of the board (as compared to the board shown in the various FIG. 3, which comprises a continuous gradient of thickness).

FIGS. 5A thru 5C are side views, showing an alternative embodiment in which the half-boards (of FIGS. 5A and 5B) combine (in FIG. 5C) to form a board with a wave-like shape of constant thickness. Such board is “non-flat.”

FIGS. 6A thru 6F are top perspective views of an alternative embodiment, showing the crosswise center medium of the various FIG. 1 with an additional wall-like element introduced.

FIGS. 7A and 7B are top views of two half-boards of an alternative embodiment in which the elements that comprise the center medium are not identical to each other but, rather, when pressed together form an integrated structural center medium of well-defined geometrical shapes.

FIG. 7C is a top view, showing the flipped half-board of FIG. 7A positioned above the half-board of FIG. 7B, just before the two half-boards are pressed together.

FIG. 7D is a top view, showing the half-boards of FIGS. 7A and 7B after they have been pressed together, thereby, forming a full board.

FIGS. 8A and 8B are top views of two half-boards of an alternative embodiment in which two different design shapes are comprised within the crosswise center medium of each half-board.

FIG. 8C is a top view, showing the half-board of FIG. 8A flipped over and positioned above the half-board of FIG. 8B, just before the two half-boards are pressed together.

FIG. 8D is a top view, showing the half-boards of FIGS. 8A and 8B after they have been pressed together, thereby, forming a full board.

FIGS. 9A and 9B are top views of two half-boards of an alternative embodiment in which more than two different design shapes are comprised within the crosswise center medium of each half-board.

FIG. 9C is a top view, showing the half-board of FIG. 9A flipped over and positioned above the half-board of FIG. 9B, just before the two half-boards are pressed together.

FIG. 9D is a top view, showing the half-boards of FIGS. 9A and 9B after they have been pressed together, thereby, forming a full board.

FIGS. 10A thru 10D, show the design of the crosswise center medium of FIGS. 9A thru 9D laid out as a repeat pattern.

### DETAILED DESCRIPTION OF THE PREFERRED EMBODIMENT OF THE INVENTION AND THE DRAWINGS

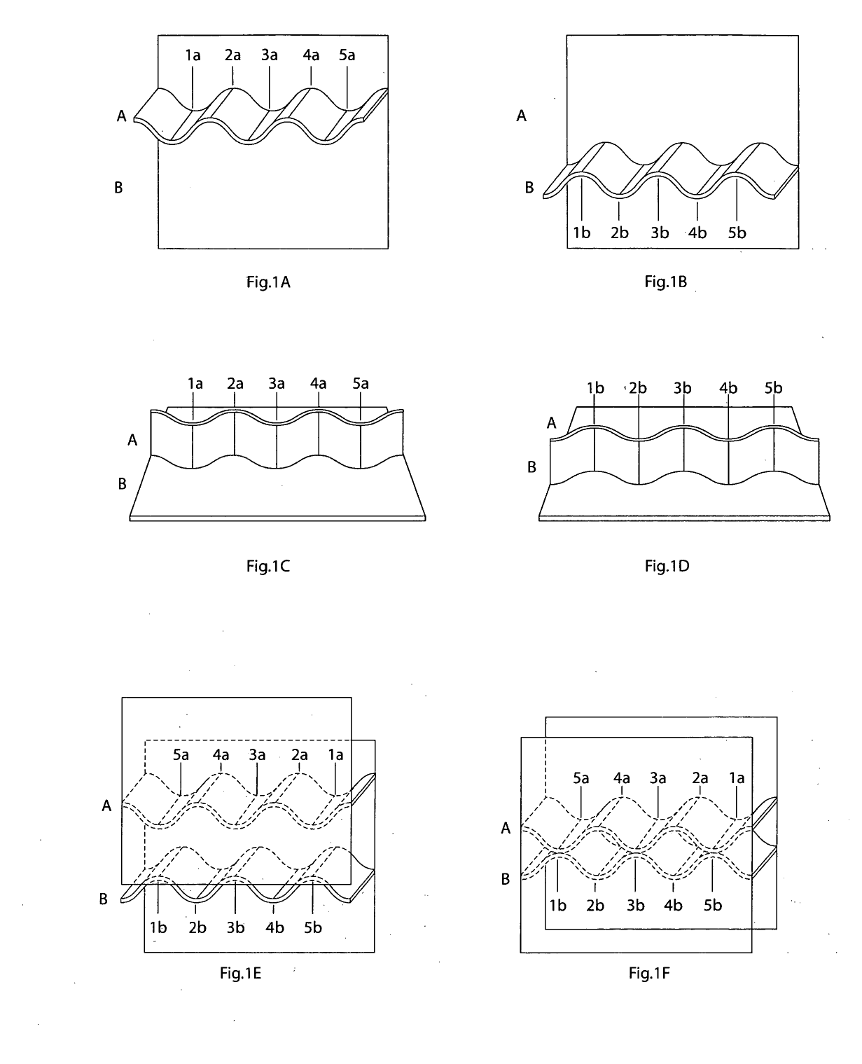

Each of FIGS. 1A and 1B shows a top perspective view of a half-board. In each of such Figs., a projecting element extends from the flat outer sheet and forms a component of one row of a crosswise center medium, attached to the outer sheet. The wall element runs across the sheet in a wavelike pattern, comprising a series of peaks and valleys. The outer sheets of both Figs. are of the same dimensions. For purposes of illustration and explanation, the positions that the various valleys and peaks occupy along the horizontal axis of the sheet in FIG. 1A are indicated by the numbers 1a, 2a, 3a, 4a and 5a. The positions that the various peaks and valleys occupy along the horizontal axis of the sheet in FIG. 1B are indicated by the numbers 1b, 2b, 3b, 4b and 5b.

In FIG. 1A the peaks are in positions that begin with even numbers (2a and 4a), and the valleys are in positions that begin with odd numbers (1a, 3a and 5a). In FIG. 1B, the reverse is the case; the peaks are in positions that begin with odd numbers (1b, 3b and 5b), and the valleys are in positions that begin with even numbers (2b, 4b). Accordingly, the peaks and valleys are laterally offset with respect to each other along the horizontal axes of FIGS. 1A and 1B.

Similarly, in FIG. 1A, the crosswise center medium extends across its respective outer sheet at a higher level (Level A) than does the crosswise center medium in FIG. 1B (Level B). Accordingly, the peaks and valleys are vertically offset with respect to each other, i.e., along the vertical axes of FIGS. 1A and 1B.

FIGS. 1C and 1D are perspective views of the half-boards shown in FIGS. 1A and 1B, looking across the horizontal plane of such boards.

Certain elements of FIGS. 1E and 1F are illustrated with dotted lines, as the view is looking through the top sheet.

FIG. 1E is a top perspective view, showing the half-board of FIG. 1A flipped over, i.e., so that the crosswise center medium of each board is between the outer sheets; now, by assembly, the outer sheets oppose one another as inner facing sheets separated by the thickness of the crosswise center medium of the half-boards. The half-board of FIG. 1A is positioned above the half-board of FIG. 1B just before the two half-boards are pressed together.

FIG. 1F is a top perspective view, showing the half-boards of FIGS. 1A and 1B after they have been pressed together. As shown in FIG. 1F, the combined elements from each half-board form the aforementioned repeating pattern of honeycomb shapes, characteristic of the preferred embodiment. In FIG. 1F, the peaks of the half-board of FIG. 1A are horizontally aligned with the valleys of the half-board of FIG. 1B, and visa versa. In essence, such peaks and valleys form mirror images of each other.

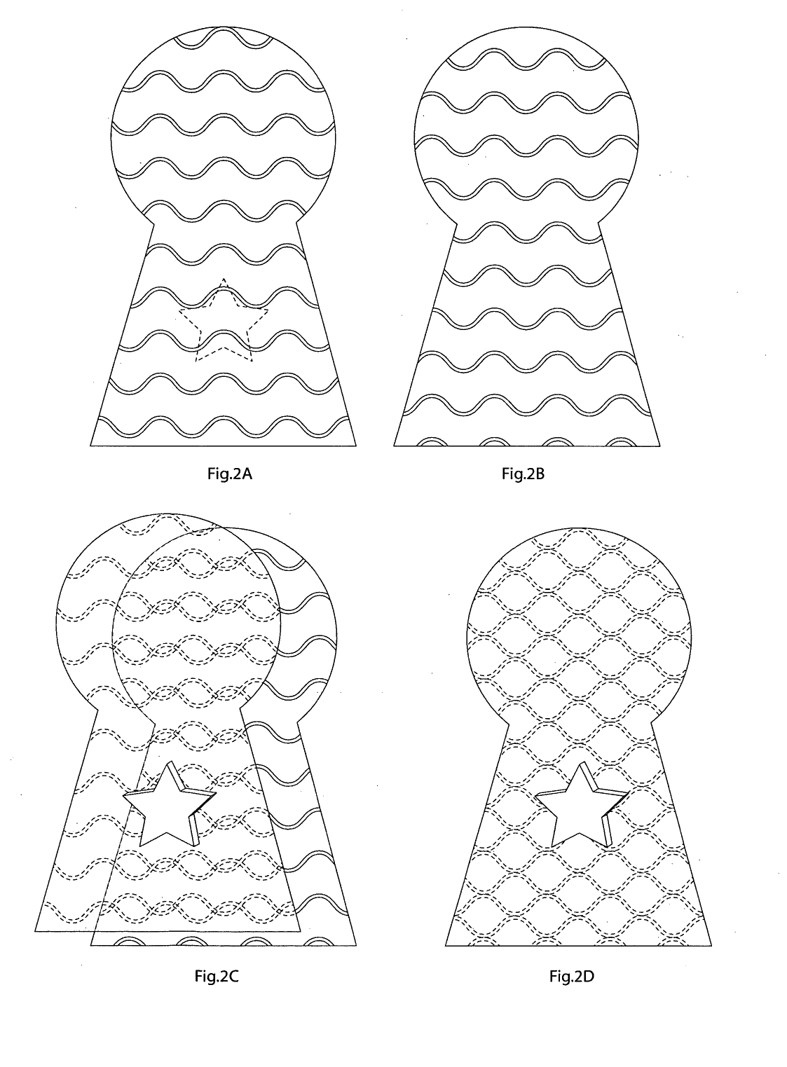

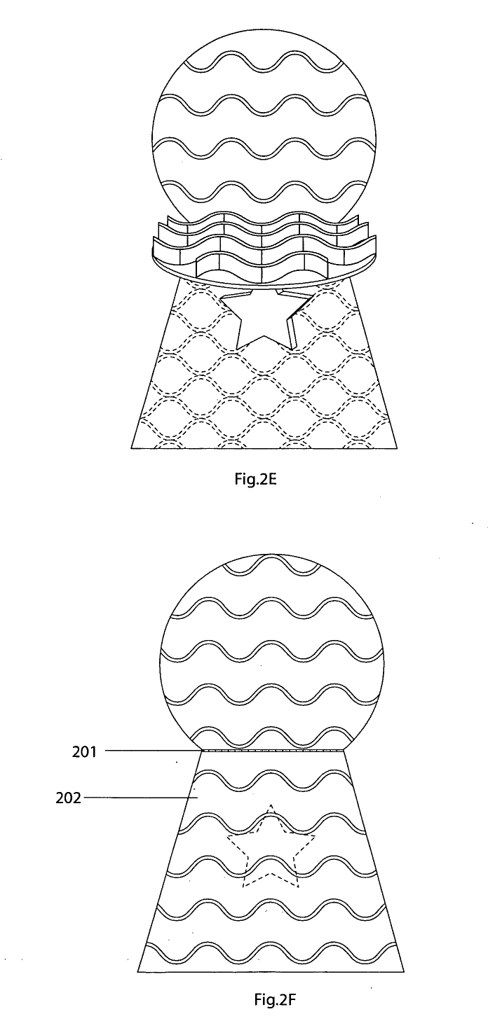

FIGS. 2A and 2B show two half-boards comprising a circle atop a triangularly shaped base. Each of such half-boards comprises a plurality of rows of crosswise center medium. FIG. 2C shows the half-board of FIG. 2A flipped and positioned above the half-board of FIG. 2B just before the two half-boards are pressed together. FIG. 2D shows the half-boards of FIGS. 2A and 2B after they have been pressed together, thereby, forming the repeating honeycomb pattern of the preferred embodiment. FIG. 2D further shows a star-shaped design element that rises as a slight mound from the outer skin of the half-board shown in FIG. 2A.

As an advantage of the present invention, the half-boards of FIGS. 2A and 2B (including the star-shaped design element of FIG. 2A) can be molded in a single operation in the circle-atop-triangular-base shape. Thereafter, the two half-boards can simply be pressed together to both form the crosswise center medium and create the final shape, as shown in FIG. 2D. Prior to the present invention, the circle-atop-triangular-base shape would have to be made by first manufacturing a rectangular board with a crosswise center medium. Secondarily, the board would be die cut into the circle-atop-triangular-base shape. Thirdly, the star-shaped design element would have to be attached to the board in a separate manufacturing operation.

FIG. 2E is the same as FIG. 2D, except that the circular portion of the half-board shown has been separated from its half-board counterpart, and turned downward. The circular portions could easily be pressed back together into the position shown in FIG. 2D. Accordingly, as illustrated by FIG. 2E, the circular portion of a half-board can occupy either an inward facing (FIG. 2D) or downward facing (FIG. 2E) position. This illustrates an advantage of the present invention in that a single element of a half-board, such as the circular portion of FIG. 2E, can occupy more than one position. In certain applications, this may allow designated portions of a half-board to perform more than one function. To provide such functionality using a die cut manufacturing method would be more difficult and expensive to achieve.

FIG. 2F shows a cut line (201) that was made to allow the circular portion of the half-board in FIG. 2E to turn downwardly. Such type of cut, which goes partially through the thickness of outer wall 202, is commonly referred to in the plastics industry as a “living hinge.” As an advantage of the present invention, a living hinge can be created as part of the basic molding process. Under the manufacturing methods available heretofore, the living hinge would have to be either scored across the plastic or made as part of a die cut process.

### DETAILED DESCRIPTION OF ALTERNATIVE EMBODIMENTS OF THE INVENTION AND THE DRAWINGS

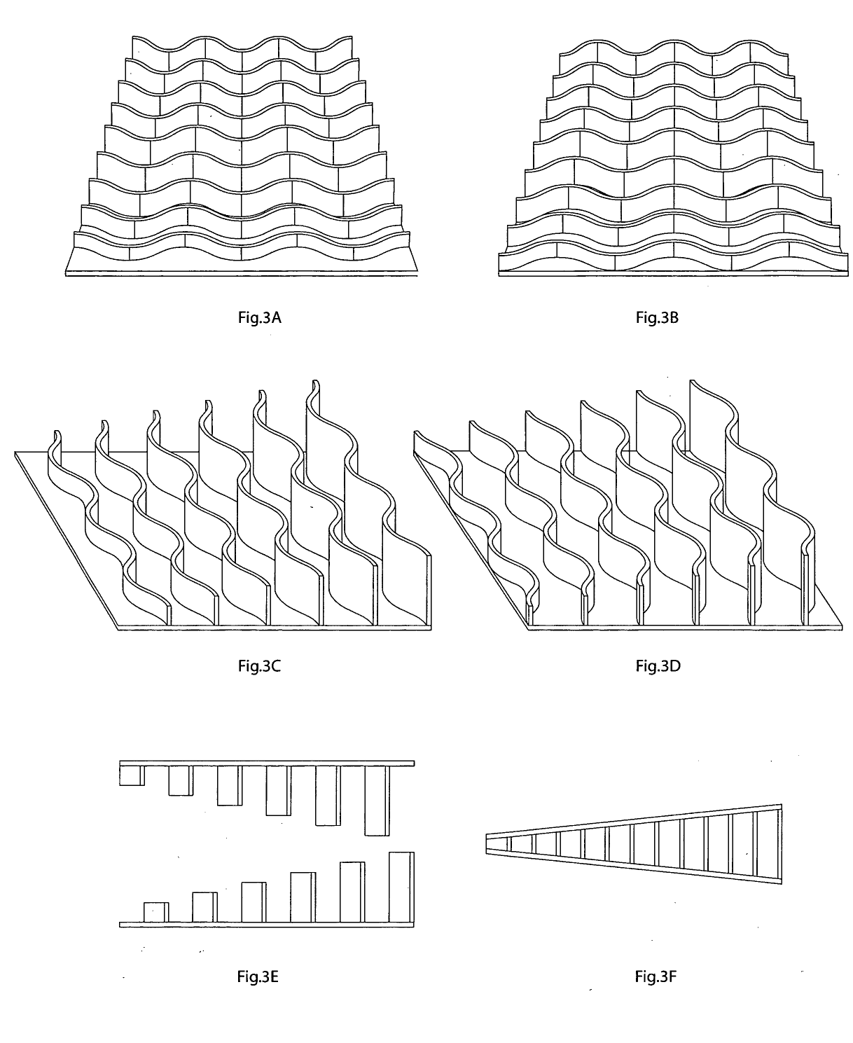

FIGS. 3A thru 3F show an alternative embodiment of the present invention, comprising a completely assembled crosswise center medium board with a continuous gradient of thickness. FIGS. 3A and 3B show compatible half-boards, each of which has a crosswise center medium that increases in height as it progresses from front edge to back. FIGS. 3C and 3D show the drawings of FIGS. 3A and 3B turned 90 degrees clockwise, respectively, for ease of illustration. FIG. 3E is a side view of the half-board of FIG. 3C flipped over and positioned above the half-board of FIG. 3D just before the two half-boards are pressed together. FIG. 3F is a side view of half-boards of FIGS. 3C and 3D after they have been pressed together, resulting in a fully formed board with a continuous and constant gradient of thickness. The crosswise center medium of FIG. 3F (not shown) comprises the honeycomb pattern of the preferred embodiment.

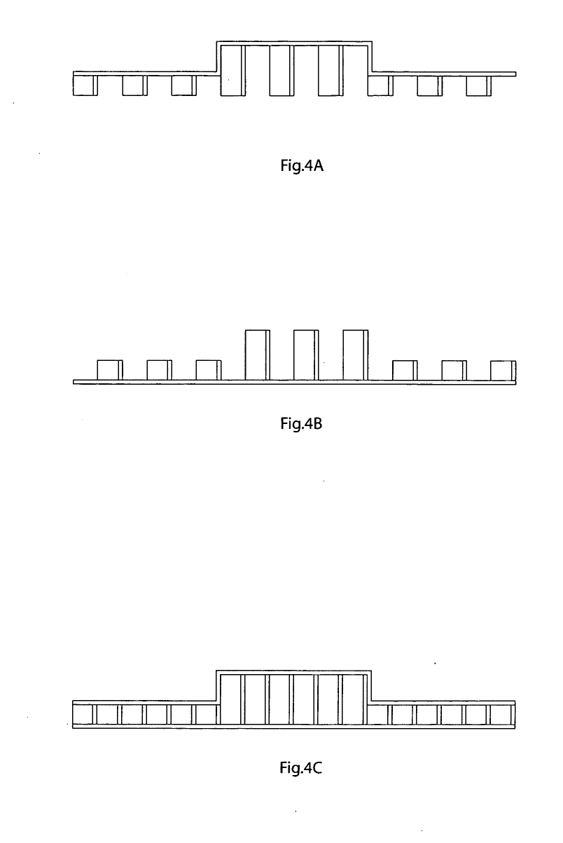

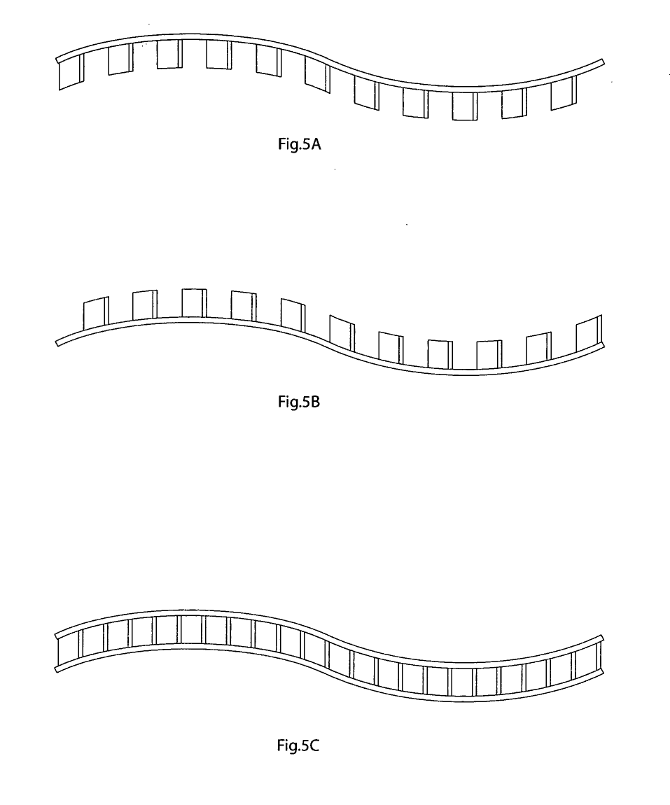

FIGS. 4A thru 4C show an alternative embodiment of the present invention, in which the thickness of the crosswise center medium is increased and then decreased in discrete steps, going from left to right. FIGS. 4A and 4B are side views of compatible half boards. FIG. 4C is a side view of the half-boards of FIGS. 4A and 4B after they have been pressed together, resulting in a fully-formed board that comprises the aforementioned discrete steps of thickness. The design shown in FIG. 4C would be more difficult and expensive to make from a flat rectangular sheet using a die cut method.

FIGS. 5A thru 5C show an alternative embodiment of the present invention, in which the outer skin of the board, in combination with the crosswise center medium, form a wavelike pattern. FIGS. 5A and 5B are side views of compatible half boards. In each of FIGS. 5A and 5B, both the elements of the crosswise center mediums and outer sheets form wavelike patterns. FIG. 5C is a side view of the half-boards of FIGS. 5A and 5B after they have been pressed together, resulting in a fully-formed board that comprises the aforementioned wavelike pattern.

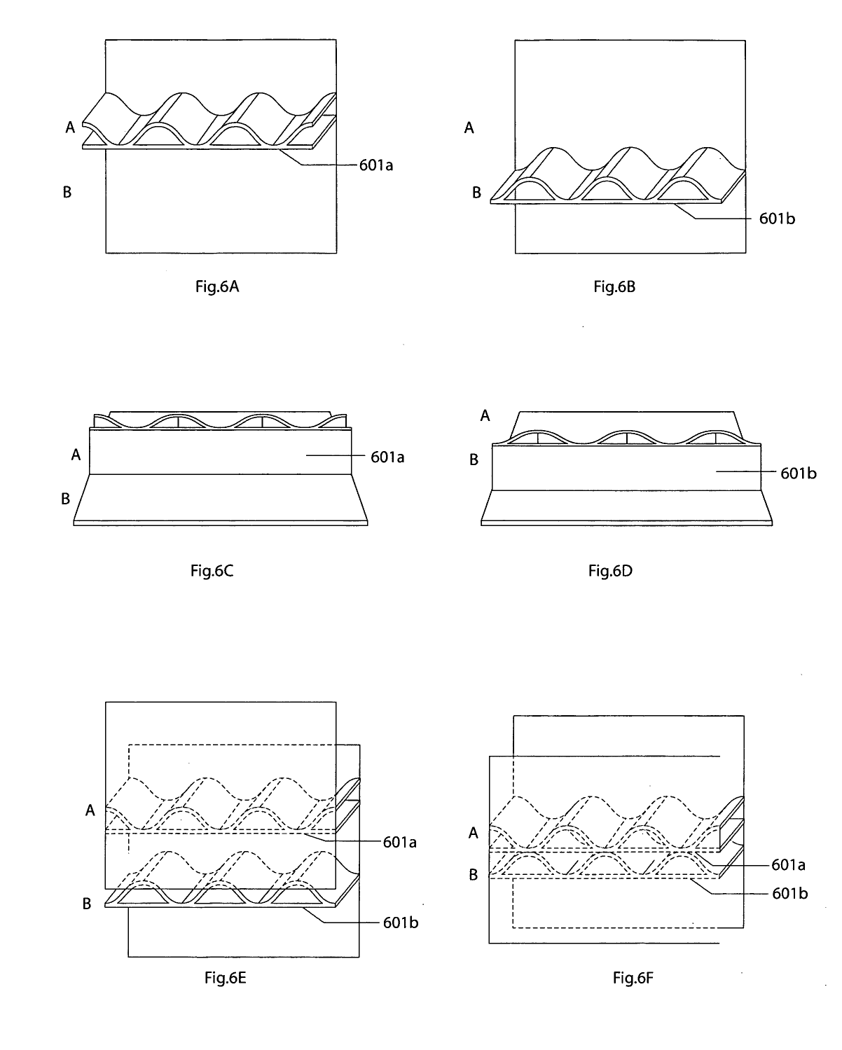

FIGS. 6A thru 6F show an alternative embodiment of the present invention, in which the honeycomb shapes of the preferred embodiment are buttressed by a support wall that serves to increase the strength of the fully formed board. FIGS. 6A and 6B show compatible half-boards of this embodiment of the present invention. The crosswise center medium of FIG. 6A is the same as that of FIG. 1A with the addition of support wall 601a, which runs horizontally across the crosswise center medium, touching the bottom of each valley. Similarly, the crosswise center medium of FIG. 6B is the same as that of FIG. 1B with the addition of support wall 601b, which runs horizontally across the crosswise center medium, touching the bottom of each valley.

FIGS. 6C and 6D are perspective views of the half-boards shown in FIGS. 6A and 6B, looking across the horizontal plane of the boards.

Certain elements of FIGS. 6E and 6F are illustrated with dotted lines, as the view is looking through the top sheet. FIG. 6E shows the half-board of FIG. 6A flipped over and positioned above the half-board of FIG. 6B just before the two half-boards are pressed together. FIG. 6F shows the half-boards of FIGS. 6A and 6B after they have been pressed together.

As shown in FIG. 6F, the crosswise center medium comprises support wall 601a which runs through the center of each honeycomb shape. Such support wall 601a serves to increase the strength of the board. Similarly, support wall 601b serves to increase the strength of the board. The design of the crosswise center medium disclosed in the various FIG. 6 would be more difficult and expensive to make from flat rectangular sheet using a die cut method.

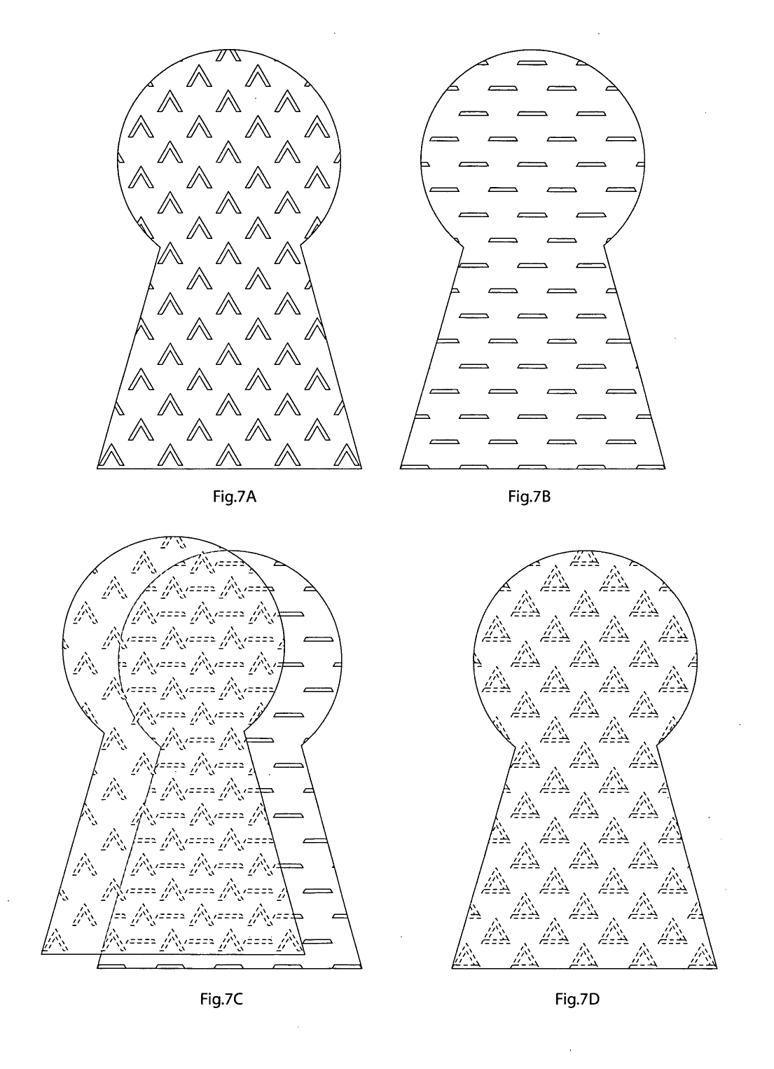

FIGS. 7A thru 7D show an alternative embodiment of the present invention, in which the elements of the crosswise center medium of one full board are not identical to those of the other half-board. FIGS. 7A and 7B show compatible half-boards of this embodiment of the present invention. The crosswise center medium elements of FIG. 7A comprise a series of horizontal rows of upward facing arrowhead shapes. The crosswise center medium elements of FIG. 7B comprise a series of rows of horizontal straight lines with beveled ends. The crosswise center medium elements of FIGS. 7A and 7B are vertically offset with respect to each other, such that the two half-boards and their respective crosswise center medium elements inter-fit together, as shown in FIG. 7D, and form structural triangles.

Certain elements of FIGS. 7C and 7D are illustrated with dotted lines, as the view is looking through the top sheet. FIG. 7C shows the half-board of FIG. 7A flipped and positioned above the half-board of FIG. 7B just before the two half-boards are pressed together. FIG. 7D shows the half-boards of FIGS. 7A and 7B after they have been pressed together. As shown in FIG. 7D, after the two half-boards have been pressed together, the crosswise center medium element comprises a series of triangles. The crosswise center medium elements of FIG. 7A comprise the legs of each triangle, and the crosswise center medium elements of FIG. 7B comprise the interlocking base of each triangle.

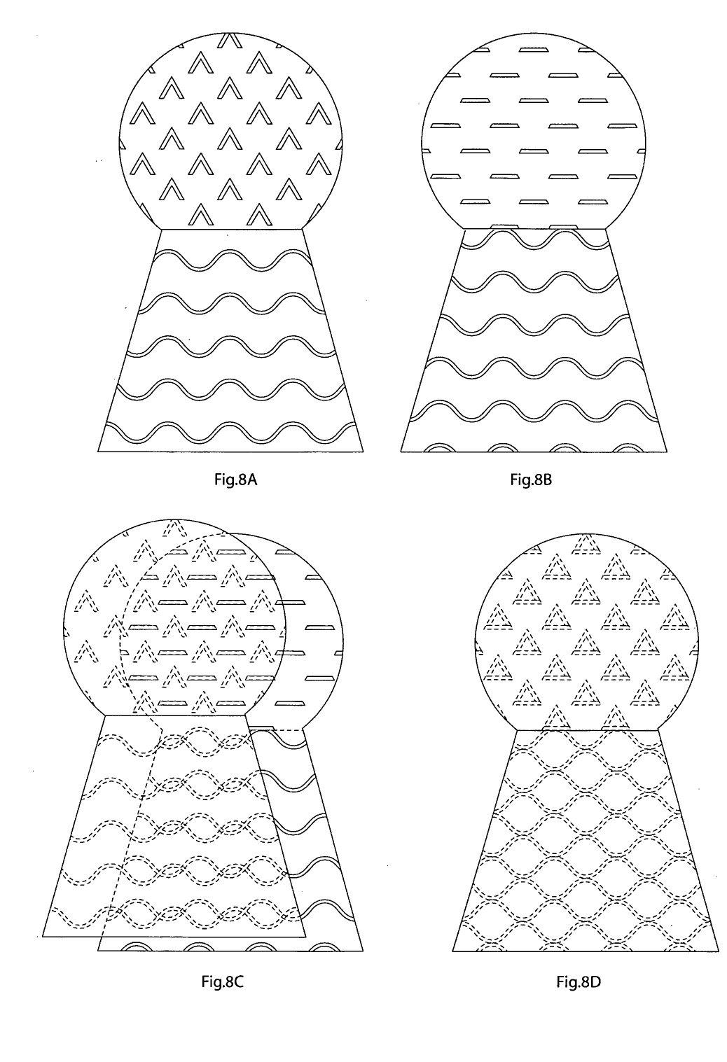

FIGS. 8A thru 8D show an alternative embodiment of the present invention, in which two different design shapes are comprised within the crosswise center medium of one full board. FIGS. 8A and 8B show two half-boards comprising the circle-atop-triangular-base shape of FIGS. 2A and 2B. In FIGS. 8A and 8B, the circular (top) part of the board comprises the arrowhead shapes and horizontal straight lines disclosed in FIGS. 7A and 7B, respectively; the triangular (bottom) part of the board comprises the wavelike shapes disclosed in FIGS. 1A and 1B, respectively, and in FIGS. 2A and 2B, respectively. FIG. 8C shows the half-board of FIG. 8A flipped and positioned above the half-board of FIG. 8B just before the two half-boards are pressed together. FIG. 8D shows the half-boards of FIGS. 8A and 8B after they have been pressed together, thereby, forming (i) the triangular shapes disclosed in FIG. 7D in the circular part of the board and the honeycomb shapes disclosed in FIGS. 1F and 2D in the triangular part of the board. The design shown in FIG. 8D would be more difficult and expensive to make from flat rectangular sheet using a die cut method.

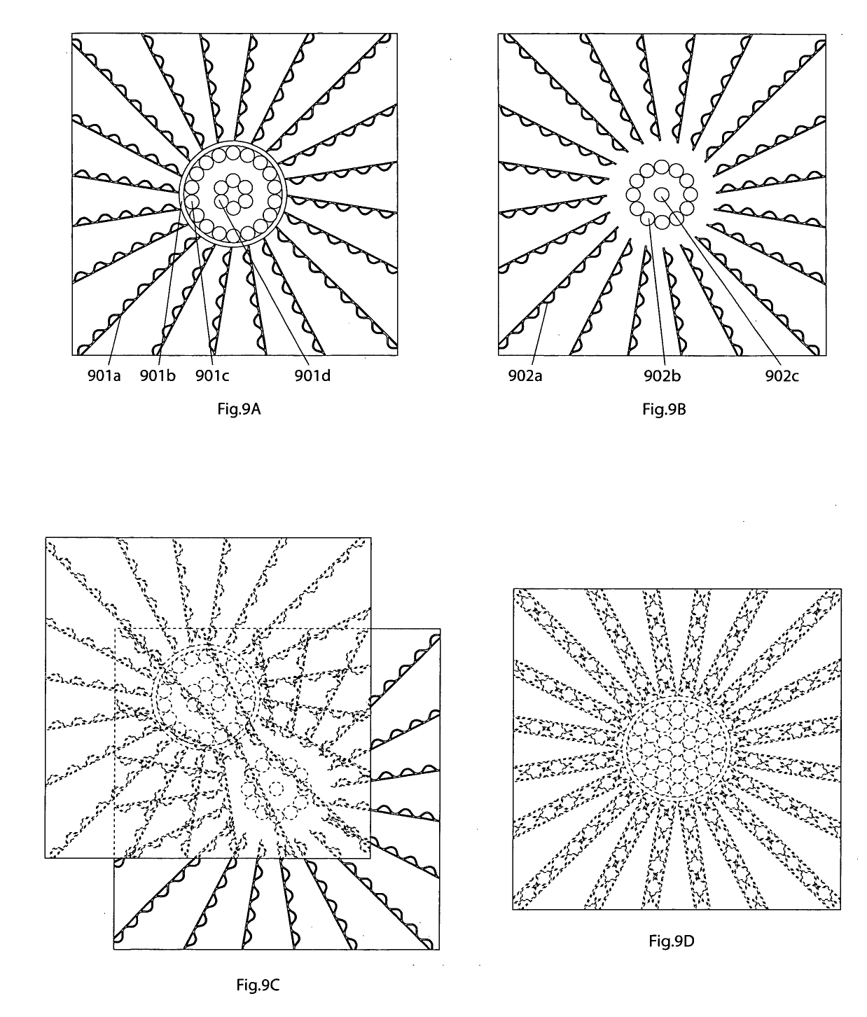

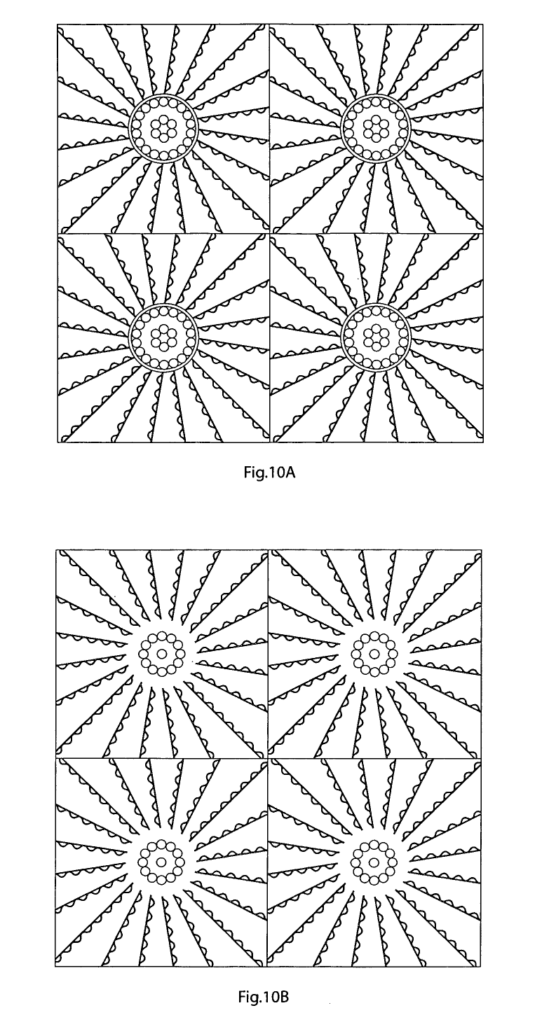

FIGS. 9A thru 9D show an alternative embodiment of the present invention, in which a plurality of different design shapes are comprised within the crosswise center medium of one full board. The design patterns disclosed in FIGS. 9A thru 9D are more complex than those disclosed in FIGS. 8A thru 8D. FIG. 9A is a rectangularly-shaped half-board comprising: (i) outwardly radiating half-spokes 901a, (ii) a circular ring 901b, (iii) an outer set of circles 901c and (iv) an inner set of circles 901d. FIG. 9B is a rectangularly-shaped half-board comprising: (i) outwardly radiating half-spokes 902a, (ii) outer set of circles 902b and (iii) an inner circle 902c. FIG. 9C shows the half-board of FIG. 9A flipped over and positioned above, but offset over, the half-board of FIG. 9B just before the two half-boards are pressed together.

FIG. 9D shows the half-boards of FIGS. 9A and 9B after they have been pressed together, thereby, forming a full board, the crosswise center medium of which comprises (i) a set of outwardly radiating spokes around (ii) a circular ring in the center of which is a group of circles. In FIG. 9D: (i) the outwardly radiating spokes are formed by inter-fitting half-spokes 901a (FIG. 9A) with half-spokes 902a (FIG. 9B) and (ii) the circular ring around a group of circles are formed by inter-fitting circular ring 901b (FIG. 9A), outer set of circles 901c (FIG. 9A) and inner set of circles 901d(FIG. 9A) with outer set of circles 902b (FIG. 9B) and inner circle 902c (FIG. 9B). The crosswise center medium that comprises the outwardly radiating spokes of FIG. 9D forms a pattern of honeycomb shapes, in this case with center support walls, similar to that shown in FIGS. 6A and 6B.

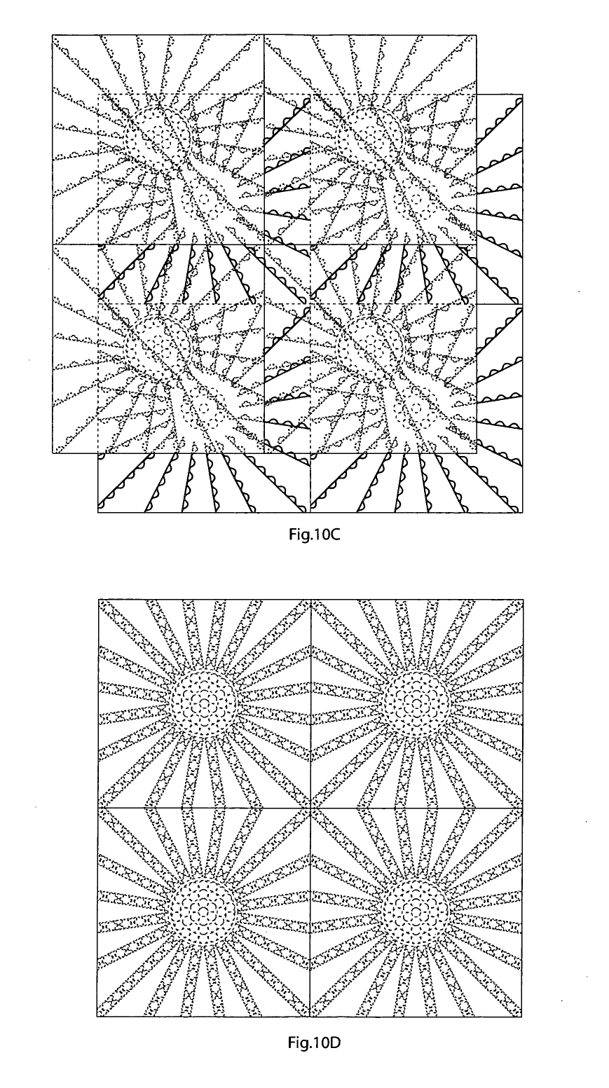

FIGS. 10A thru 10D, show the design of the crosswise center medium of FIGS. 9A thru 9D laid out as a repeat pattern. Each of FIGS. 10A and 10B shows four squares laid out adjacent to one another; each square contains the corresponding elements of the design of the crosswise center medium disclosed in FIGS. 9A and 9B, respectively. FIG. 10C shows the half-board of FIG. 10A flipped over and positioned above the half-board of FIG. 10B just before the two half-boards are pressed together. FIG. 10D shows the half-boards of FIGS. 10A and 10B after they have been pressed together. As shown in FIG. 10D, the combined elements from each half-board form a repeating pattern (4 repeats in a 2×2 pattern) of the crosswise center medium design disclosed in FIG. 9D.

The aforementioned preferred and alternative embodiments of the present invention, illustrate that boards can be formed comprising both simple and complex patterns of the crosswise center medium. The pattern within that medium may form either symmetrical or asymmetrical shapes and may be comprised of either identical or non-identical elements on the various half-boards. Furthermore, the height of the elements of the crosswise center medium may vary, thereby, forming either a continuous gradient of thickness or discrete steps of different thicknesses across the board's length. Any combinations of these features may be combined within one board, thereby, forming a plurality of embodiments.

The patterns of the crosswise center medium disclosed in FIG. 9D can be used to redistribute the various forms of stress (such as weight or impact) to which the completed boards may be subjected. For example, the outwardly radiating spokes of FIG. 9D might be used to redistribute stress from the center of the board to the outer periphery. Similarly, other patterns and variations of the crosswise center medium may be used to either redistribute stress, or increase or decrease the stress resistant properties of a particular portion of a board. The flexibility of the patterns allows for conservation of weight and material while maintaining strength, as needed. Such patterns and variations include the continuous gradient variation (disclosed in FIGS. 3A thru 3F), the discrete steps (disclosed in FIGS. 4A thru 4C), the wavelike patterns (disclosed in FIGS. 5A thru 5C), the non-identical shapes (disclosed in FIGS. 7A thru 7D) and the different design shapes comprised within the crosswise center medium of one full board (FIGS. 8A thru 8D).

While the above description contains many specificities, these should not be construed as limitations on the scope of the invention, but rather as exemplifications of one or more embodiments thereof. Other variations and embodiments are possible. Those who are skilled in the art will readily perceive how to modify the invention. Therefore, the appended claims are to be construed to cover all equivalent structures which fall within the true scope and spirit of the invention and should not be limited to the embodiments illustrated.

We claim:

1. A board formed from two half-boards, each of said half-boards comprising an outer sheet and one or more elements attached crosswise to said outer sheet, each of said elements of one half-board capable of being inter-fitted with, or lying opposite, the elements of the other half board, so that when assembled into a fully formed board, said fully formed board comprises a crosswise center medium that lies between a pair of opposed outer sheets.

2. The board of claim 1, wherein said crosswise center medium forms a repeating pattern of shapes.

3. The board of claim 1, wherein said crosswise center medium forms a repeating pattern of shapes that cover, essentially, the entire area of the board that lies between said opposed outer sheets.

4. The board of claim 1, wherein the outer dimensions of said fully formed board are not rectangular in shape.

5. The board of claim 1, wherein said crosswise center medium forms a repeating pattern of shapes that cover, essentially, the entire area of the board that lies between said opposed outer sheets and the outer dimensions of said fully formed board are not rectangular in shape.

6. The board of claim 1, wherein said crosswise center medium forms a continuous gradient of thickness.

7. The board of claim 1, wherein said crosswise center medium forms a plurality of discrete thicknesses.

8. The board of claim 1, wherein said crosswise center medium and said opposed outer sheets form a wavelike pattern.

9. The board of claim 1, wherein said elements on one half-board are identical to said elements on the other half-board.

10. The board of claim 1, wherein said elements on one half-board are not identical to said elements on the other half-board.

11. The board of claim 1, wherein the elements within one full board comprise a plurality of different design shapes.
